(19) United States
(12) Patent Application Publication
(10) Pub. No.: US 2007/0064656 A1
(43) Pub. Date: Mar. 22, 2007

(54) Physical random access channel frame structure and realization

(75) Inventors: Ling Lv, Shanghai (CN); Tao Wu, Eastwood (AU); Baikui Xu, Shanghai (CN); Xingyin Tian, Shenzhen (CN)

Correspondence Address: PERKINS COIE LLP;PATENT-SEA, P.O. BOX 1247, SEATTLE, WA, 98111-1247, US

(73) Assignee: Spreadtrum Communications Corporation, Sunnyvale, CA (US)

(21) Appl. No.: 11/525,248

(22) Filed: Sep. 20, 2006

(30) Foreign Application Priority Data
Sep. 20, 2005 (CN) 200510029798.3

(51) Int. Cl. H04B 7/216

(52) U.S. Cl. 370/335

(57) ABSTRACT

New PRACH frame structures and methods for implementing such structures for use in mobile communication systems are disclosed. The PRACH frame structures can include a lengthened message portion. A system can broadcast the PRACH message portion length N in individual cells from a based station. If access condition is satisfied, a user equipment can encode, multiplex and modulate original message bits according to the broadcasted message portion length. The modulated PRACH signals can then be sent to the base station to be demodulated according to the broadcasted message portion length.

### CROSS-REFERENCE TO RELATED APPLICATION(S)

This application claims priority to Chinese Patent Application No. 200510029798.3filed on Sep. 20, 2005, the disclosure of which is incorporated herein by reference in its entirety.

### TECHNICAL FIELD

The present disclosure relates to call setup methods and procedures in mobile communication systems. In particular, the present disclosure relates to a new Physical Random Access Channel (PRACH) frame structure and realization for transmitting increased amount of information during random access procedures.

### BACKGROUND

A call setup process in a conventional 3G system is depicted in FIG. 1 and FIG. 2, using a first User Equipment (UE) calling a second UE as an example. As illustrated in these figures, the conventional 3G system incorporates several main functional entities including User Equipment (UE), NodeB, Radio Network Controller (RNC), and Core Network (CN). In the illustrated figures, it is assumed that a user initiates a Push to talk Over Cellular (PoC) service in the Packet Service (PS) domain, and Radio Resource Control (RRC) connection is built on a Dedicated Channel (DCH).

For the originating UE, the call setup process usually includes the following steps: (1) RRC connection setup; (2) Non-access Stratum (NAS) signaling setup and NAS signaling interaction; and (3) Radio Access Bearer (RAB) setup. For the receiving UE, the call setup process is similar to that of the originating UE and includes the following steps: (1) paging; (2) RRC connection setup; (3) Non-access Stratum (NAS) signaling setup and NAS signaling interaction; and (4) Radio Access Bearer (RAB) setup.

The purpose for establishing the RRC connection is to establish a dedicated signaling channel between the UE and the UTRAN (Universal Terrestrial Radio Access Network, typically including several RNC and NodeB) to transmit signals between the UE and the network and between the UE and the CN.

In communication systems, the duration of the call setup (or call setup delay) is a major factor affecting the quality of service. In some systems, such as in interaction games, emergent voice calls, Push to talk Over Cellular (PoC), which are sensitive to the duration delay, the call setup delay is relatively long in current systems (usually 6 to 10 seconds).

In order to reduce the call setup delay, the message sent from the UE to the network during RRC connection setup may need to be increased. For example, more information (such as traffic type) can be transmitted to realize faster access during the RRC connection procedure. Thus, more bits need to be sent via the Random Access Channel (RACH) for the transmission of RRC connection request. For a physical layer, RACH is sent via the Physical Random Access Channel (PRACH). Therefore, a new PRACH frame structure is required to meet such a demand.

In Wideband Code Division Multiple Access (WCDMA) systems, the PRACH frame structure is represented as in FIG. 3. As illustrated, after the access Preamble, there is 10 ms or 20 ms to transmit the RRC connection request. In Time Division-Synchronized Code Division Multiple Access (TD-SCDMA) systems, the PRACH is similar to the frame structure of DCH, as depicted in FIG. 4. The PRACH message portion length is 5 ms, 10 ms, or 20 ms. Thus, in all these systems, the maximum message length value of the PRACH can be too small to transmit a large amount of information.

### BRIEF DESCRIPTION OF THE DRAWINGS

FIG. 1 is a flow chart of a call setup procedure at an originating end in accordance with the prior art.

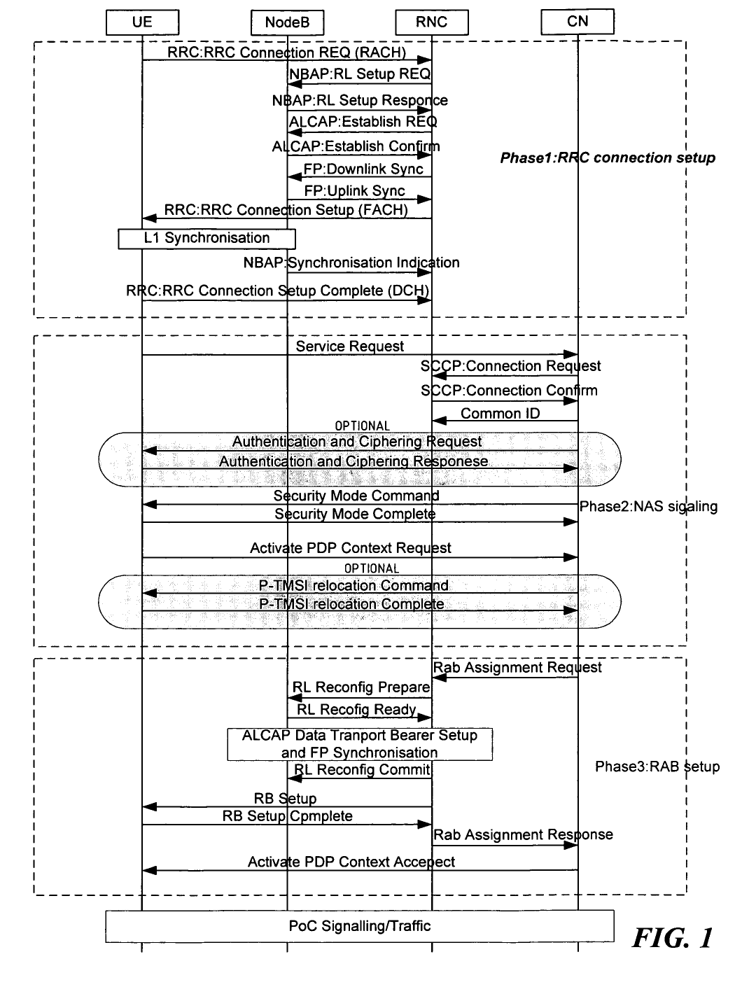

FIG. 2 is a flow chart of a call setup procedure at a receiving end in accordance with the prior art.

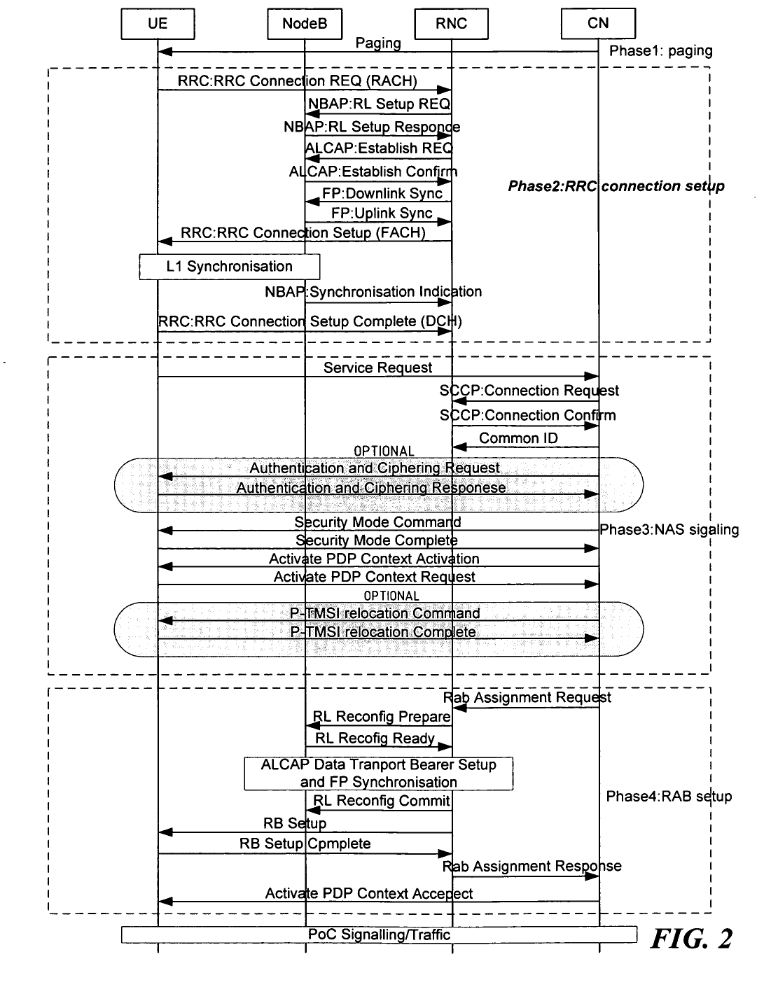

FIG. 3 is a PRACH frame structure in a WCDMA system in accordance with the prior art.

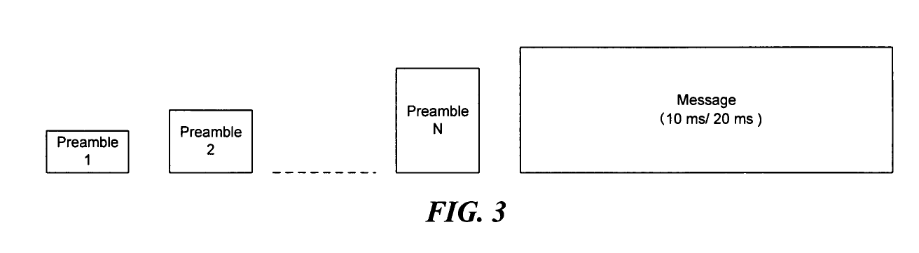

FIG. 4 is a PRACH frame structure in a TD-SCDMA system in accordance with the prior art.

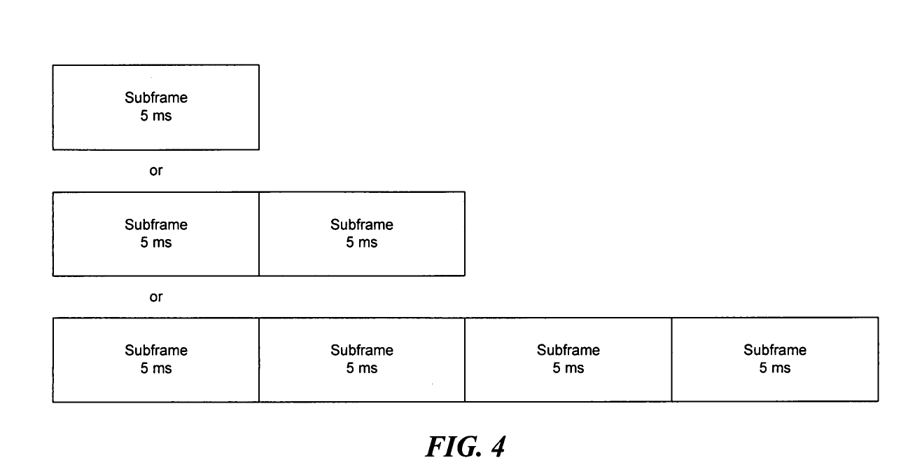

FIG. 5 is a PRACH frame structure in a WCDMA system in accordance with an embodiment of the present invention.

FIG. 6 is a PRACH frame structure in a TD-SCDMA system in accordance with another embodiment of the present invention.

### DETAIL DESCRIPTIONS

One aspect of the present invention relates to a new PRACH frame structure that includes a lengthened PRACH message portion. In a WCDMA system, the PRACH message portion length can be prolonged to N frames (where N can be 4-8), and the length of each frame is 10 ms or 20 ms. In a TD-SCDMA system, the PRACH message portion length can be prolonged to N sub-frames (where N can be 4-8), and the length of each frame is 5 ms.

Another aspect of the present invention relates to a method of realizing the PRACH frame structure described above. The method includes broadcasting the PRACH message portion length N in the cell via the system Broadcast Channel (BCH). A UE can initiate a call procedure within the cell when access is wanted. If access condition is satisfied, the UE can encode, multiplex, and modulate original message bits according to the broadcasted message portion length N, and send the PRACH signals to a base station. The base station can then demodulate the PRACH signals, and send the messages to RNC and CN to complete the access procedure. In a WCDMA system, the allowable access condition is that the received Access Indicator (Al) is 1. In a TD-SCDMA system, the allowable access condition is that a Forward Access Channel (FACH) configuration is received.

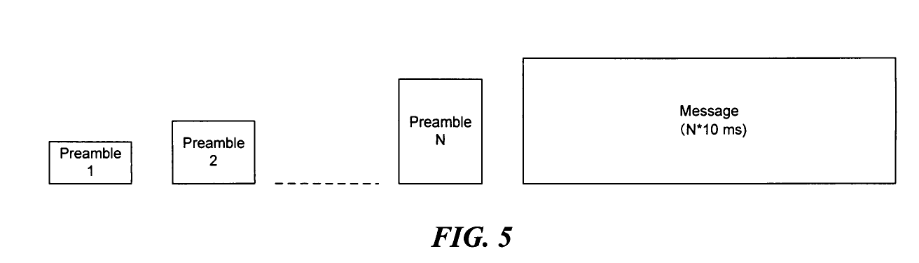

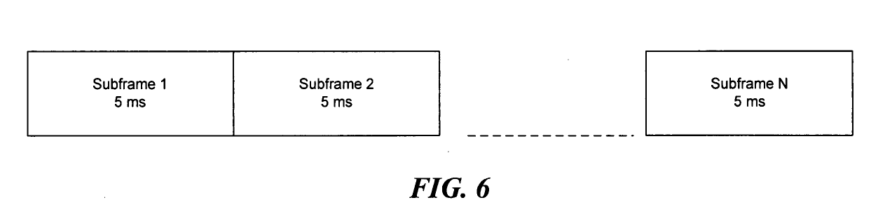

In one embodiment, the PRACH message portion can be lengthened to N frames/sub-frames. The amount of transmitted information can determine the value for N after satisfying the uplink requirement. Typically, N can have a value of 4-8, as illustrated in FIG. 5 (a WCDMA system) and in FIG. 6 (a TD-SCDMA system).

The PRACH message portion length N can be broadcasted in a cell via the system Broadcast Channel (BCH). A UE can initiate a call procedure within the cell when access is required. When access is allowed, the UE can encode, multiplex, and demodulate the original bits according to the broadcasted PRACH message portion length, and then send the PRACH signal to the base station. In a WCDMA system, the allowable access condition is that the received Access Indicator (Al) is 1. In a TD-SCDMA system, the allowable access condition is that a Forward Access Channel (FACH) configuration is received. The base station can then demodulate the PRACH signals, and transmit the messages to RNC and CN to allow the RNC and CN to complete the access procedures.

The following description uses a WCDMA system as an example to illustrate an embodiment of the present invention. In the illustrated embodiment, the length of the PRACH message portion can be determined to be 4 frames based on the system network planning, the cell traffic type, and the Radio Resource Management (RRM) algorithm. The network can broadcast system messages including the PRACH message portion length via the system Broadcast Channel (BCH).

After power is on and a cell search is completed, a UE can receive and demodulates the system messages broadcasted via the BCH to obtain the PRACH message portion length. When the user of the UE needs to make a call, the UE sends the Preamble of the PRACH. The system then receives the Preamble of PRACH sent from the UE, and sends the Access Indicator (Al) via the Access Indicator Channel (AICH) to grant access to the UE. The UE then receives the Al, encodes and modulates the signal according to the requirement that the PRACH message portion length is 4 frames, before sending the PRACH message to the system. When the system receives the PRACH message, the system demodulates the PRACH message according to the requirement that the PRACH message portion length is 4 frames, executes corresponding signaling handling processes, and performs other access procedure to complete the call.

From the foregoing, it will be appreciated that specific embodiments of the invention have been described herein for purposes of illustration, but that various modifications may be made without deviating from the invention. For example, the lengthened PRACH frame structure can be implemented in other types of communication systems (e.g., GSM systems). Certain aspects of the invention described in the context of particular embodiments may be combined or eliminated in other embodiments. Accordingly, the invention is not limited except as by the appended claims.

I/We claim:

1. A Physical Random Access Channel frame structure, comprising a message part having a length that is greater than 4 sub-frames.

2. The frame structure of claim 1, wherein the message part length is 4 to 8 sub-frames in a WCDMA system.

3. The frame structure of claim 2, wherein each sub-frame has a length of 10 ms or 20 ms.

4. The frame structure of claim 1, wherein the message part length is 4 to 8 sub-frames in a TD-SCDMA system.

5. The frame structure of claim 4, wherein each sub-frame has a length of 5 ms.

6. A method, comprising:
broadcasting a Physical Random Access Channel message portion length N from a base station to a user equipment in a cell;
encoding, multiplexing, and modulating original bits according to the broadcasted PRACH message portion length N at the user equipment;
sending the modulated original bits from the user equipment to the base station;
demodulating the original bits at the base station according to the broadcasted PRACH message portion length N; and
transmitting the demodulated original bits from the base station to a radio network controller and a core network.

7. The method of claim 6, further comprising completing access procedures using the radio network controller and the core network.

8. The method of claim 6, wherein the allowable access condition is that the received Access Indicator is 1 in a WCDMA system.

9. The method of claim 6, wherein the allowable access condition is that a Forward Access Channel (FACH) configuration is received in a TD-SCDMA system.
